(19) United States
(12) Patent Application Publication
(10) Pub. No.: US 2014/0122806 A1
(43) Pub. Date: May 1, 2014

(54) CACHE DEVICE FOR SENSOR DATA AND CACHING METHOD FOR THE SAME

(71) Applicant: DELTA ELECTRONICS, INC., Taoyuan County (TW)

(72) Inventors: Keng-Yi LIN, Taoyuan County (TW); Guang-Joung CHEN, Taoyuan County (TW); Yao-Chiang WANG, Taoyuan County (TW); Hsueh-Hsing CHAO, Taoyuan County (TW)

(73) Assignee: DELTA ELECTRONICS, INC., Taoyuan County (TW)

(21) Appl. No.: 13/757,164

(22) Filed: Feb. 1, 2013

(30) Foreign Application Priority Data
Oct. 31, 2012 (TW) 101140219

(51) Int. Cl. G06F 12/08

(52) U.S. Cl. CPC G06F 12/0875
USPC 711/126

(57) ABSTRACT

A cache device includes a cache module, which comprises a sensor data access interface, a sensor data acquisition module and a driver library. The sensor data access interface receives a data request of back-end sensors from a front-end monitoring system. The sensor data acquisition module inquiries the sensors for the sensor data in accordance with the received request, receives and saves sensor data from the sensors, and replies the sensor data to the monitoring system through the sensor data access interface. The driver library includes at least one driver program, the sensor data acquisition module reads the sensors via executing the driver program, wherein, the driver library selects a corresponding communication protocol which is used by the inquired sensors for the executed driver program to use thereto.

This application is based on and claims the benefit of Taiwan Application No. 101140219 filed Oct. 31, 2012 the entire disclosure of which is incorporated by reference herein.

### BACKGROUND OF THE INVENTION

1. Field of the Invention

The present invention relates to a cache device for sensor data and caching method for the same, particularly to a cache device used in sensor network and bridging among a front-end monitoring system and sensors, and caching method for the same.

2. Description of Related Art

FIG. 1 shows a schematic diagram of a related art sensor network system. In the shown system, a monitoring system (for example, one of the first monitoring system 11, the second monitoring system, and the Nth monitoring system 13) needs to establish a direct wired or wireless connection with the sensor 2 when the monitoring system intends to access the sensor data of the sensor 2. Therefore, the monitoring system can send request to the sensor 2 and receive the replied sensor date from the inquired sensor 2.

In the network system shown in FIG. 1, connection problem arises when the number of the monitoring systems 11-13 are excessive, or when the number of the sensors 2 are excessive. For example, the first monitoring system 11 is required to support 10001/O accessing when the first monitoring system 11 intends to read data from the 1000 sensors. This causes difficulty for the product developer. Moreover, if a sensor 2 is accessed by excessive monitoring system (for example, 100 monitoring systems simultaneously read the sensor and in the cycle of 5 seconds), the sensor 2 will have over load problem and have the risk of damage.

Moreover, the current commercially-available sensors have various types and the sensors of different types may have different communication protocols. The product development is difficult and may be prolonged if the sensors need to be compatible with all communication protocols.

Accordingly, it is desirable to provide a novel cache device to overcome above problems by reducing actual reading numbers of the sensors without the expense of monitoring system performance. Moreover, it is also desirable to provide a novel cache device to facilitate the development of new monitoring system by releasing protocol compatibility constrain for the monitoring system.

### SUMMARY OF THE INVENTION

It is an object of the present invention to provide a cache device for sensor data and caching method for the same, the cache device bridges among a front-end monitoring system and sensors and integrates inquiries from front-end monitoring system to reduce actual reading frequency of the sensors and prevent the damage of sensor due to overload.

It is another object of the present invention to provide a cache device for sensor data and caching method for the same, the cache device integrates various communication protocols used by sensors and sends inquiry to the sensor for the front-end monitoring system, whereby the front-end monitoring system can acquire sensor data even though the front-end monitoring system does not support the communication protocol of an inquired sensor.

Accordingly, the present invention provides a cache device for sensor data and the cache device comprising a cache module. The cache module comprises a sensor data access interface, a sensor data acquisition module, and a device driver library. The sensor data access interface receives at least one request sent from the front-end monitoring system and requests sensor data from the sensors. The sensor data acquisition module sends inquiry to the sensors according to the request and temporarily stores sensor data from the sensors after receiving the sensor data. The sensor data acquisition module replies the sensor data to the front-end monitoring system through the sensor data access interface. The device driver library stores a plurality of driver programs and is operatively connected to the sensor data acquisition module. The sensor data acquisition module reads the sensor through executing the driver programs. The device driver library selects at least one corresponding communication protocol used by the inquired sensors, the driver programs are executed to communicate with the sensors according to the corresponding communication protocol.

The cache device of the present invention is provided among the front-end monitoring system and the sensors, and capable of integrating requests for the sensors from the front-end monitoring system, as well as sends inquiry to the sensors according to an optimal replying frequency. The actual read frequency of the sensor can be advantageously reduced. The cache device of the present invention sends inquiry to the sensors for the front-end monitoring system to overcome the overload problem caused by too many requests from the front-end monitoring system and to prevent the sensor from damage due to overload.

Moreover, the current front-end monitoring system has development difficulty due to the capability constrain to various communication protocols. The cache device of the present invention integrates the communication protocols for various sensors and sends inquiry to the sensors on behalf of the front-end monitoring system. The front-end monitoring system can obtain sensor data from the sensors by sending request to the cache device of the present invention through simple and ordinary communication. The development obstacle can be overcome and the development time can be shortened because the communication protocol is not a factor in development of the front-end monitoring system.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a schematic diagram of a related art sensor network system.

FIG. 2 shows the schematic diagram of the first embodiment of the present invention.

FIG. 3 shows the schematic diagram of the cache device 4 according to a first embodiment of the present invention.

FIG. 4 shows the schematic diagram for the sensor data access interface according to the first embodiment of the present disclosure.

FIG. 5 shows the schematic diagram of the device driver library according to the first embodiment of the present disclosure.

FIG. 6 shows a schematic diagram of the sensor communication protocol binder according to the first embodiment of the present disclosure.

FIG. 7 shows the sensor inquiry flowcharts according to the second embodiment of the present invention.

FIG. 8 shows the sensor inquiry flowcharts according to the second embodiment of the present invention.

FIG. 9 shows the schematic diagram of the cache module according to the second embodiment of the present invention.

FIG. 10 shows the schematic diagram of the cache module according to the third embodiment of the present invention.

FIG. 11 shows the connection diagram for the second embodiment of the present invention.

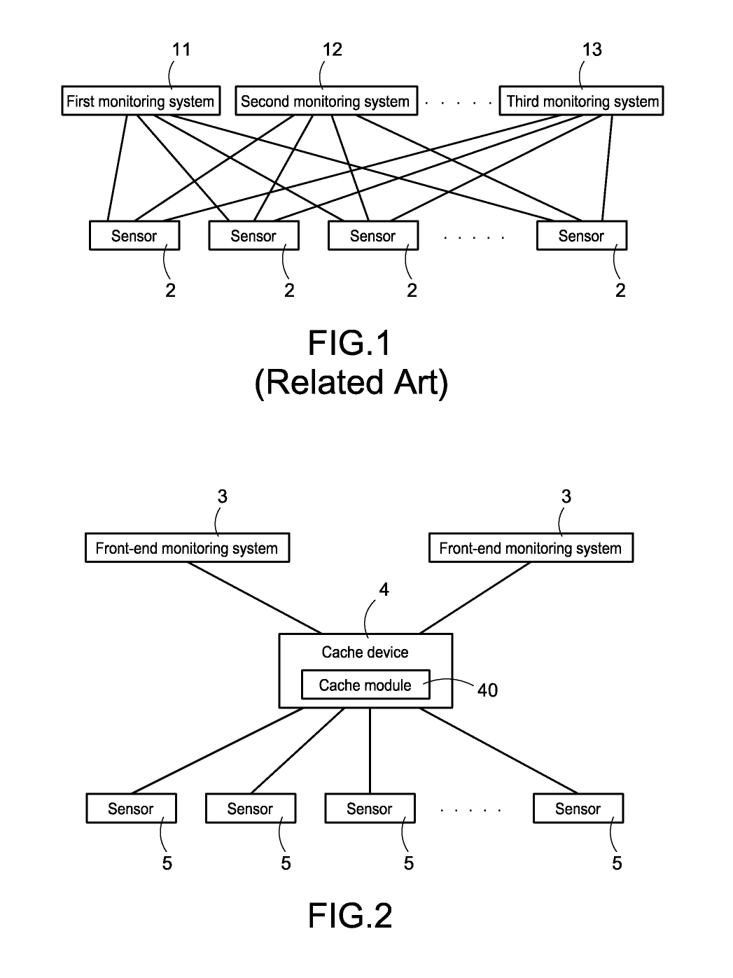

### DETAILED DESCRIPTION OF THE INVENTION

FIG. 2 shows the schematic diagram of the first embodiment of the present invention. As shown in this figure, the present invention mainly discloses a cache device 4 for sensor data (hereinafter the cache device 4 for sensor data is referred to cache device 4 for brevity), and the cache device 4 is connected among at least one front-end monitoring system 3 and a plurality of sensors 5 and functioned as bridge between the front-end monitoring system 3 and the plurality of sensors 5. More particularly, the cache device 4 sends data requests to the sensors 4 for the front-end monitoring system 3, and the cache device 4 replies the requested sensor data to the front-end monitoring system 3 for the sensors 5. Therefore, the front-end monitoring system 3 can obtain the sensor data from all sensors by sending request to the cache device 4, and the sensor 5 can reply to all front-end monitoring systems 3 (if the front-end monitoring systems 3 have multiple numbers) by replying only to the cache device 4. The front-end monitoring system 3 can be developed with ease and the sensors can be prevented from damage caused by overload.

It should be noted that the cache device 4 can be operatively connected to the front-end monitoring system 3 and the sensors 4 through the physical connection ports thereon or wireless network card, or the cache device 4 can be operatively connected to the front-end monitoring system 3 and the sensors 5 through a gateway. However, above examples are not limitations of the scope of the present invention. As also shown in FIG. 2, the cache device 4 comprises a cache module 40 and the cache device 4 processes the data of the front-end monitoring system 3 and the sensors 5 by the cache module 40. In another example of the present invention, the cache module 40 can be implemented in one of the front-end monitoring system 3 and used as the cache device. However, the scope of the present invention is not limited by above specific examples.

As shown in FIG. 2, the cache device 4 is operatively connected among at least one front-end monitoring system 3 and the sensors 5. The cache device 4 processes the request from the front-end monitoring system 3 and send corresponding inquiry to the sensors 5. The cache module 40 can further temporarily store the sensor data from the sensors 5 and then reply to the front-end monitoring system 3 according to the asked replying frequency of the front-end monitoring system 3

In this shown embodiment, the front-end monitoring system 3 can be, for example, an energy manage system, a real time network monitoring board, a hand-held monitoring system (such as a panel computer or a mobile phone with monitoring program) or sensor manage tool in personal computer. The sensors 5 can be, for example, an electric meter, a water meter, a gas meter, a temperature meter, an oil meter, a window sensor, a personnel sensor, a movement sensor, a vibration sensor, a photo intensity sensor, a wind speed/direction sensor, an air quality sensor, a water quality sensor or a soil composition sensor. However, above-mentioned examples are used for demonstration and are not limitation of the present disclosure.

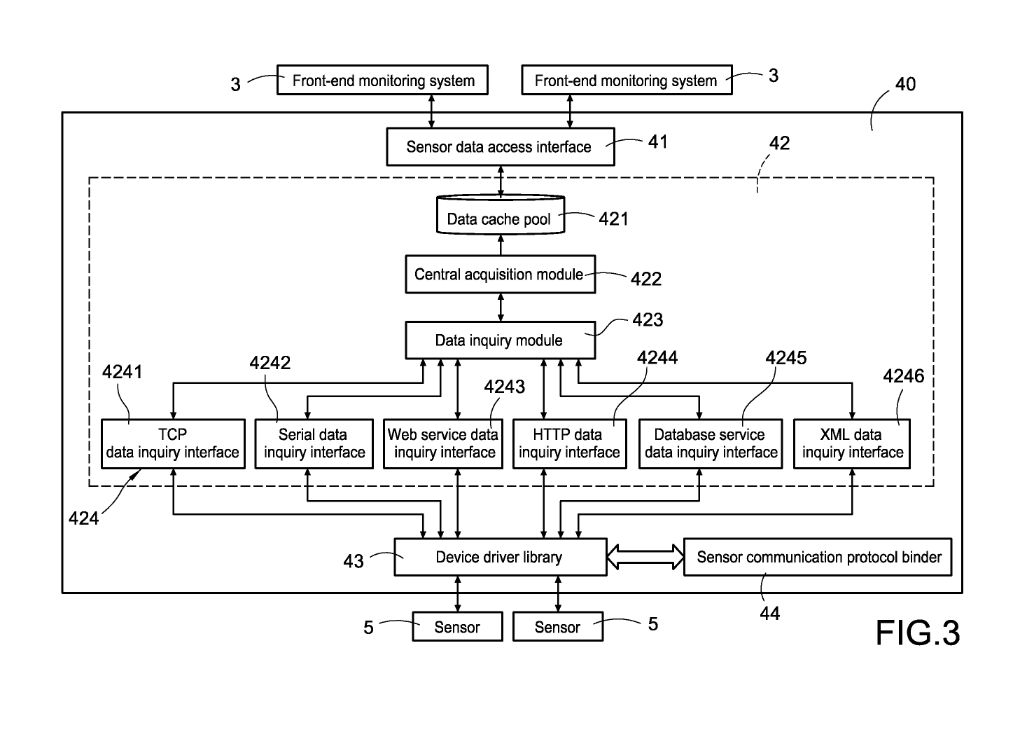

With reference to FIG. 3, this figure shows the schematic diagram of the cache device 4 according to a first embodiment of the present invention. In this embodiment, the cache module 40 mainly comprises a sensor data access interface 41, a sensor data acquisition module 42, a device driver library 43 and a sensor communication protocol binder 44. The sensor data access interface 41 is used to receive request from the front-end monitoring system 3, and more particularly, the request from the front-end monitoring system 3 and intended to request the sensor data of the sensors 5. In this embodiment, the request from the front-end monitoring system 5 and received by the cache device 4 may be toward specific one, two, at least two or all sensors, and sensor number is not limitation of the present disclosure.

The sensor data acquisition module 42 obtains the request of the front-end monitoring system 3 from the sensor data access interface 41 and sends inquiry to the sensors 5 according to the request. The sensor data acquisition module 42 can preferably perform a temporary storing operation after get the replied sensor data from the sensor to ensure the cache device 4 to have the latest sensor data. In this embodiment, the sensor data acquisition module 42 will not inquiry a specific sensor 5 and the specific sensor 5 will not reply data if the front-end monitoring system 3 does not have request to the specific sensor 5. For example, the sensor data acquisition module 42 will send inquiry to the sensors A and B if the front-end monitoring system 3 has only sent the request for the sensors A and B to the cache device 4. The sensor data acquisition module 42 will reply the sensor data of the sensors A and B to the front-end monitoring system 3 sending the requests.

The device driver library 43 has a plurality of driver programs. The driver programs are executed to connect the sensors 5 to be inquired when the sensor data acquisition module 42 sends inquiry to the sensors 5. The sensor communication protocol binder 44 records a plurality of communication protocols and the communication protocols are used (or potentially used) by the sensors 5. The device driver library 43 will access the sensor communication protocol binder 44 to read the communication protocols for the sensors 5 to be inquired when the driver programs are executed. Therefore, the driver programs can communicate with the sensors 5 to be inquired through the corresponding communication protocols.

For example, the device driver library 43 obtains the OPC communication protocol from the sensor communication protocol binder 44 when the sensor C to be inquired uses the OPC communication protocol, whereby at least one of the driver programs can communicate with the sensor C through the OPC communication protocol. Therefore, the front-end monitoring system 3 (if not supporting the OPC communication protocol) still can send request to the cache device 4 through more popular communication protocol (such as TCP) and then access the data of the sensor C through the cache device 4.

As shown in FIG. 3, the sensor data acquisition module 42 mainly comprises a data cache pool 421, a central acquisition module 422, a data inquiry module 423, and a plurality of data inquiry interfaces 424. The data cache pool 421 is, for example, a memory matrix to temporarily store the replied sensor data from the sensors 5, thus ensuring that the data stored in the cache device 4 is the latest one.

The plurality of data inquiry interfaces 424 are corresponding to inquiries of different types and execute one of the driver programs to send inquire to the sensors 5 of the corresponding types as inquiring the sensors 5. As shown in FIG. 3, the plurality of data inquiry interfaces 424 comprises, for example, a TCP data inquiry interface 4241, a serial data inquiry interface 4242, a web service data inquiry interface 4243, an HTTP data inquiry interface 4244, a database service data inquiry interface 4245 and an XML data inquiry interface 4246. However, the above examples are only for demonstration and are not limitation of the present disclosure. The type and amount of the plurality of data inquiry interfaces 424 can be adjusted according to practical need.

As shown in FIG. 3, the TCP data inquiry interface 4241 is used to inquire TCP type sensors and to receive replies from the sensors. The serial data inquiry interface 4242 is used to inquire serial sensors and to receive replies from the sensors.

The web service data inquiry interface 4243 is used to inquire web service sensor and to receive replies from the sensors. For example, part of the sensor data may be from the information of weather bureau website rather than from physical sensor (such sensed weather data). In this case, the weather bureau website or server may be deemed as one of the sensors 5 and the web service data inquiry interface 4243 is in charge of inquiring the weather bureau website or server, and receiving the sensor data from the sensor (namely, the weather bureau website or server).

The HTTP data inquiry interface 4244 is used to inquire the HTTP type sensor and to receive replies from the sensors. For example, the HTTP data inquiry interface 4244 establishes a port 80 connection to the HTTP type sensor. The sensor monitors the inquire of the HTTP data inquiry interface 4244 sent from port 80 and replies the sensor data to the HTTP data inquiry interface 4244 corresponding to the inquiry.

The database service data inquiry interface 4245 is used to inquire the database service sensor and to receive replies from the sensors. For example, some particular sensor only stores its sensor data to local end database (or database connected thereto) and does not permit external inquiry. In this case, the sensor data acquisition module 42 cannot directly inquire the database service sensor. The sensor data acquisition module 42 can only direct inquire the database connected with the database service sensor through the database service data inquiry interface 4245, and then receive the sensor data from the database. The XML data inquiry interface 4246 is used to inquire the XML sensor and to receive replies from the sensors.

The data inquiry module 423 is mainly an execution thread in the sensor data acquisition module 42. The data inquiry module 423 controls the data inquiry interfaces 424 to send inquiry to the sensors 5 and to receive the replied sensor data from the sensors. The central acquisition module 422 is used to collect the sensor data from the data inquiry module 423 (namely, the sensor data received through the data inquiry interfaces 424) and to temporarily store the sensor data in the data cache pool 421.

It should be noted that the front-end monitoring system 3 can also provide an asked replying frequency besides sending request to the sensors. The asked replying frequency is related to how often the cache device 4 should reply the latest sensor data from the sensors 5. In this embodiment, the inquiry operation of the data inquiry interfaces 424 is controlled by the data inquiry module 423 and the inquiry frequency for the sensors, which is sent from the data inquiry interfaces 424, is corresponding to the asked replying frequency of the front-end monitoring system 3.

In one embodiment, the cache device 4 will not send inquiry to the sensor unless it receives the request from the front-end monitoring system 3. In another embodiment, the front-end monitoring system 3 can simultaneously send request and asked replying frequency, while the cache device 4 determines the inquired sensor according to the request and determines the inquiry frequency and replying frequency according to the asked replying frequency.

For example, the front-end monitoring system 3 sends request to the cache device 4 and requests for the sensor data from the sensors D and E. Besides, the front-end monitoring system 3 also asks to receive sensor data from the sensor D every five minutes and to receive sensor data from the sensor E every ten minutes. Therefore, the data inquiry module 423 controls the data inquiry interfaces 424 to inquire the sensor D every five minutes and then sends the sensor data to the front-end monitoring system 3; the data inquiry module 423 controls the data inquiry interfaces 424 to inquire the sensor E every ten minutes and then sends the sensor data to the front-end monitoring system 3. More particularly, the inquiries for the sensors D and E can be sent from one data inquiry interface 424 or two data inquiry interfaces 424, depending on the types of the sensors D and E.

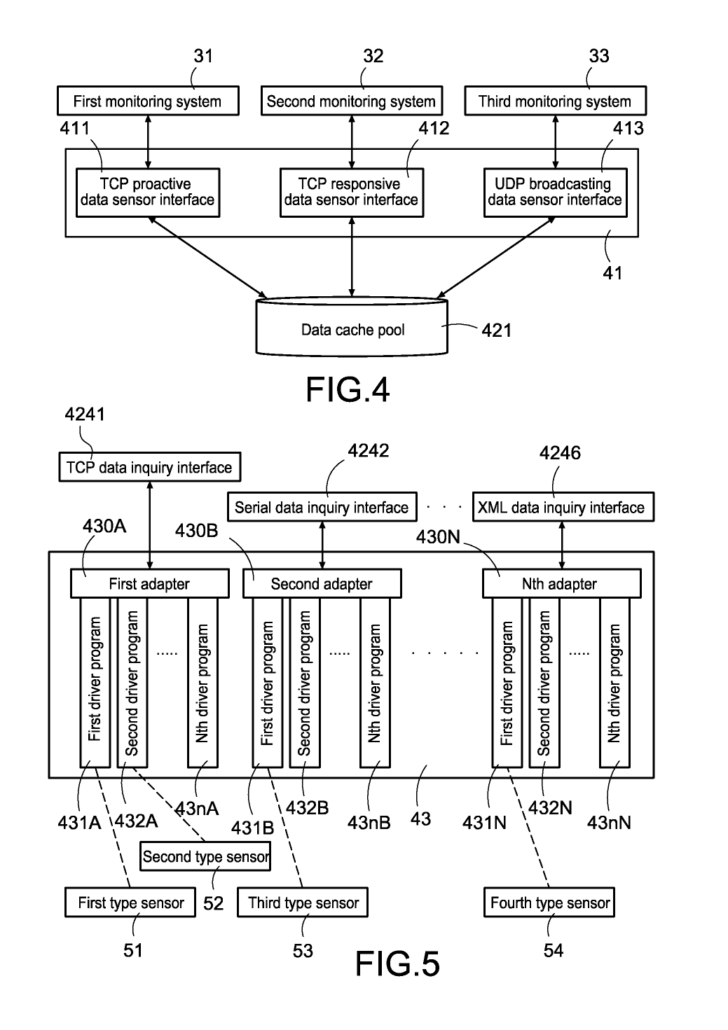

FIG. 4 shows the schematic diagram for the sensor data access interface 41 according to the first embodiment of the present disclosure. The sensor data access interface 41 in the shown embodiment comprises at least three interfaces including a TCP proactive data sensor interface 411, a TCP responsive data sensor interface 412 and a UDP broadcasting data sensor interface 413. Therefore, the front-end monitoring system 3 can send request to the cache device 4 through three different modes.

As shown in FIG. 4, a first monitoring system 31 sends request to the cache device 4 through the TCP proactive data sensor interface 411, and the request can include the inquired sensors (number of sensors) and asked replying frequency. The cache module 40 sends inquiry to the inquired sensors 5 in the frequency complied with the asked replying frequency and then sends the replied sensor data to the first monitoring system 31. Namely, the first monitoring system 31 can obtain periodical sensor data from the cache device 4 by sending only one request. Moreover, the TCP proactive data sensor interface 411 replies the sensor data to the first monitoring system 31 through TCP communication protocol.

Moreover, a second monitoring system 32 sends request to the cache device 4 through the TCP responsive data sensor interface 412 and the request can include the inquired sensors (number of sensors). Different to the example with the TCP proactive data sensor interface 411, the cache module 40 will not send inquiry to the sensors 5 unless the cache module 40 get request from the second monitoring system 32 in the embodiment implemented with the TCP responsive data sensor interface 412. In other word, the second monitoring system 32 will not receive sensor data unless it sends request. The cache device 4 will not automatically send inquiry for the second monitoring system 32 and provide the second monitoring system 32 with sensor data if the second monitoring system 32 does not send request. Moreover, the TCP responsive data sensor interface 412 replies the sensor data to the second monitoring system 32 through TCP communication protocol.

Moreover, a third monitoring system 33 sends request to the cache device 4 through UDP broadcasting data sensor interface 413, and the request can include the inquired sensors (number of sensors) and asked replying frequency. The example with the UDP broadcasting data sensor interface 413 is similar to the example with the TCP proactive data sensor interface 411, while the difference is that the UDP broadcasting data sensor interface 413 replies the sensor data to the third monitoring system 33 through UDP communication protocol.

It should be noted that the UDP broadcasting data sensor interface 413 can realize one-to-multiple transmission through broadcasting. For example, in case that the first monitoring system 31, the second monitoring system 32, and the third monitoring system 33 send periodical request to the cache device 4 for the periodical UDP data update through the TCP proactive data sensor interface 411, the UDP broadcasting data sensor interface 413 can send the sensor data to the first monitoring system 31, the second monitoring system 32, and the third monitoring system 33 by one broadcast instead of three separate data sending operations if the replying frequencies for the three monitoring systems 31, 32 and 33 are the same. Therefore, transmission speed of the cache device 4 can be enhanced and the transmission number of external transmission can be reduced. In the present embodiment, the external transmission is referred to that the cache device 4 sends the sensor data to the monitoring systems in the same intranet instead of sending the sensor data to Internet. However, the scope of the present disclosure is not limited by the above example.

FIG. 5 shows the schematic diagram of the device driver library 43 according to the first embodiment of the present disclosure. As shown in this figure, the device driver library 43 mainly comprises a plurality of adapters 430A˜430N and a plurality of driver programs 431A˜43nN. Each of the adapters 430A˜430N is operatively connected with a data inquiry interface 424 and a plurality of driver programs 431A˜43nN. In other word, each data inquiry interface 424 executes at least one of the driver programs 431A˜43nN through one of the adapters 430A˜430N.

As shown in FIG. 5, the TCP data inquiry interface 4241 is operatively connected to the first adapter 430A to execute the plurality of driver program 431A˜43nA associated with the first adapter 430A. The serial data inquiry interface 4242 is operatively connected to the second adapter 430B to execute the plurality of driver program 431B-43nB associated with the second adapter 430A. The XML data inquiry interface 4246 is operatively connected to the Nth adapter 430N to execute the plurality of driver program 431N˜43nN associated with the nth adapter 430N, and so on.

Taking the TCP data inquiry interface 4241 as example, the TCP data inquiry interface 4241 can execute the first driver program 431A through the first adapter 430A, where the first driver program 431A has the same communication protocol with the inquired first type sensors 51. Therefore, the TCP data inquiry interface 4241 can communicate with the inquired first type sensors 51, and send inquiry to the inquired first type sensors 51, as well as receive sensor data from the inquired first type sensors 51. The TCP data inquiry interface 4241 can further execute the second driver program 432A through the first adapter 430A, where the second driver program 432A has the same communication protocol with the inquired second type sensors 52. In above example, the inquired first type sensors 51 and the inquired second type sensors 52 are TCP type sensors corresponding to the TCP data inquiry interface 4241 and are inquired through the TCP data inquiry interface 4241.

Taking the serial data inquiry interface 4242 as example, the serial data inquiry interface 4242 can execute the first driver program 431B through the second adapter 430B, where the first driver program 431B has the same communication protocol with the inquired third type sensors 53. Therefore, the serial data inquiry interface 4242 can communicate with the inquired third type sensors 53, and send inquiry to the inquired third type sensors 53, as well as receive sensor data from the inquired third type sensors 53. In above example, the inquired third type sensor 53 is serial type sensor corresponding to the serial data inquiry interface 4242 and is inquired through the serial data inquiry interface 4242.

Taking the XML data inquiry interface 4246 as example, the XML data inquiry interface 4246 can execute the first driver program 431N through the Nth adapter 430N, where the first driver program 431N has the same communication protocol with the inquired fourth type sensors 54. Therefore, the XML data inquiry interface 4246 can communicate with the inquired fourth type sensors 54, and send inquiry to the inquired fourth type sensors 54, as well as receive sensor data from the inquired fourth type sensors 54. In above example, the inquired fourth type sensor 54 is XML type sensor corresponding to the XML data inquiry interface 4246 and is inquired through the XML data inquiry interface 4246.

It should be noted that the inquiry operations are classified according to the types of the data inquiry interfaces 424 to facilitate the manager of the cache device 4 to classify the sensor data. In other circumstance, the data inquiry interfaces 424 can be selected to connect to sensors 5 with protocol type different to the protocol type of the data inquiry interfaces 424. Provided that 100 sensors are installed in one building and include 99 TCP type sensors and 1 UDP type sensor, the manager can inquire all the 100 sensors through the TCP data inquiry interface 4241 directly for the simplicity of connection. The sensor data is replied to the data inquiry module 423. In this condition, the UDP type sensor can be simulated as TCP type sensor to reduce complexity of the system.

As shown in FIG. 5, each of the adapters 430A˜430N is corresponding to N driver programs (such as 431A˜43nA. 431B˜43nB. 431N˜43nN), where N is corresponding to the number of communication protocols supportable by the cache module 40. For example, provided that the TCP data inquiry interface 4241 needs to inquire M sensors and all of the communication protocols of the M sensors are different, the cache module 40 can process the M sensors with the TCP data inquiry interface 4241 as long as M is smaller than N and all communication protocols can be supported by the cache module 40.

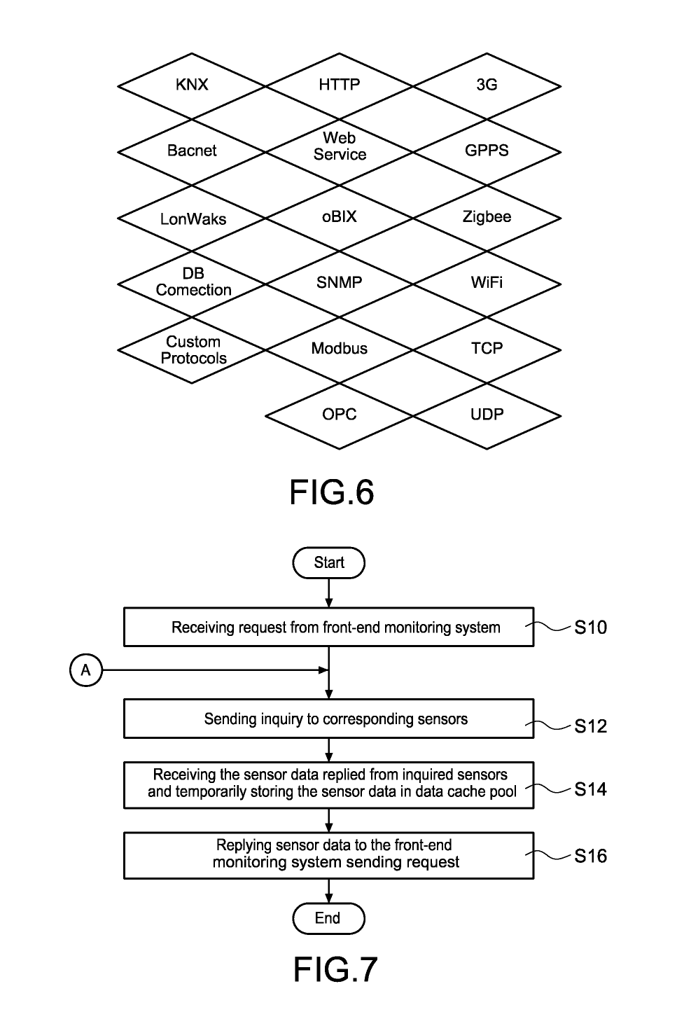

FIG. 6 shows a schematic diagram of the sensor communication protocol binder 44 according to the first embodiment of the present disclosure. As shown in this figure, many communication protocols can be pre-defined in the sensor communication protocol binder 44, and the communication protocols can be timely added, deleted or amended. The pre-defined communication protocols can be popular communication protocols in the market, or specialized communication protocols developed by manufacturers. As shown in FIG. 6, the communication protocols can include 3G, GPRS, Zigbee, WiFi, TCP, UDP, HTTP, Web service, Obix, SNMP, Modbus, OPC, KNX, BACnet, LonWorks, DB connection protocols or other custom protocols. However, above examples are only for demonstration and are not limitation of the present disclosure.

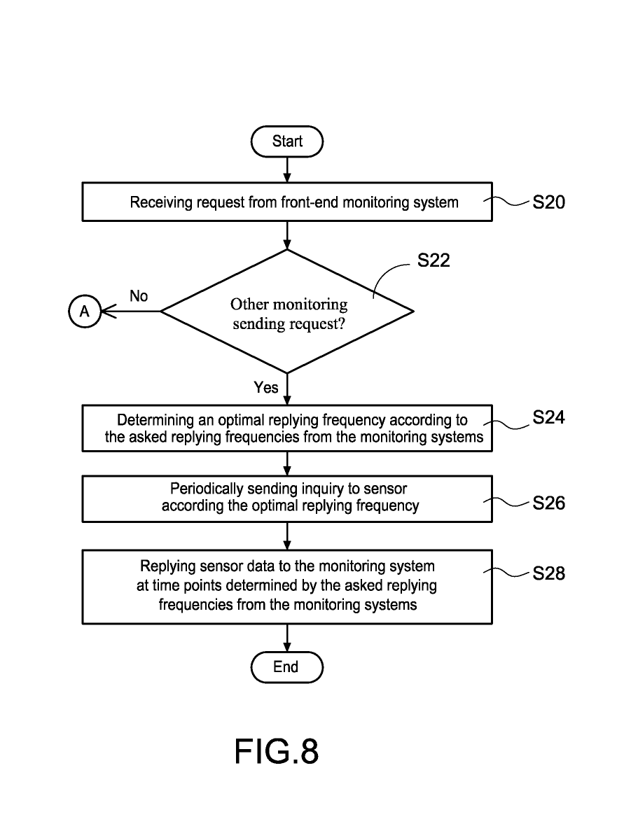

FIG. 7 and FIG. 8 show the sensor inquiry flowcharts according to the first embodiment and the second embodiment of the present invention, respectively. The present invention discloses a cache method for sensors and is mainly applied to the above-mentioned cache device 4. With reference to FIG. 7, the cache device 4 first receives, through the sensor data access interface 41 in the cache module 40, request sent from the front-end monitoring system 3 and intended to access the sensors 5 in step S10. The cache module 40 then executes corresponding driver programs 431A˜43nN through the data inquiry interfaces 424 in order to send inquiry to the inquired sensors 5 in step S12. More particularly, the cache module 40 first judges the communication protocol used by the inquired sensors 5 in step S12 such that the driver programs 431A˜43nN use corresponding communication protocol to communicate with the sensors 5 after the device driver library 43 reads the sensor communication protocol binder 44.

Afterward, the cache module 40 receives the sensor data replied from the sensors and temporarily stores the sensor data in the data cache pool 421 in step S14. The cache module 40 then sends the replied sensor data, through the sensor data access interface 41, to the front-end monitoring system 3 sending the request in step S16.

More particularly, if the front-end monitoring system 3 sends the request through the TCP proactive data sensor interface 411 or the UDP broadcasting data sensor interface, the data inquiry interfaces 424 periodically sends inquiry to the inquired sensors 5 according to the asked replying frequency requested by the front-end monitoring system 3 in step S12; the data inquiry interfaces 424 periodically sends received sensor data to the front-end monitoring system 3 according to the asked replying frequency in step S16. However, if the front-end monitoring system 3 sends the request through the TCP responsive data sensor interface 412, the data inquiry interfaces 424 inquires the inquired sensors 5 only when the front-end monitoring system 3 sends request, and the data inquiry interfaces 424 will not send inquiry or send replied sensor data for other moment.

In this embodiment, the cache module 40 can integrate the multiple requests if multiple front-end monitoring systems 3 simultaneously send requests to the cache device 4. With reference to FIG. 8, the cache device 4 first receives, through the sensor data access interface 41 in the cache module 40, requests sent from the front-end monitoring system 3 and intended to access the sensors 5 in step S20. The cache device 4 then judges whether other monitoring system (not shown) sends request to the same inquired sensors 5 in step S22. The cache module 40 performs steps similar to steps S12 to S16 shown in FIG. 7 to inquire and reply sensor data if no other monitoring system sends request to the same inquired sensors 5.

The cache module 40 optimizes the asked replying frequencies from a plurality of monitoring systems if the cache device 4 judges that other monitoring system sends request to the same inquired sensors 5 in step S24. More particularly, the cache module 40 determines an optimal replying frequency by finding a highest common factor (HCF) for those asked replying frequencies. The data inquiry interfaces 424 periodically send inquiry to the inquired sensors 5 according to the optimal replying frequency in step S26, and then receive the sensor data. The sensor data access interface 41 then replies the sensor data to the monitoring systems according to the optimal replying frequency in step S28.

The above flowchart will be demonstrated with following example: there are three monitoring systems (such as the monitoring systems 31-33 shown in FIG. 4), where the first monitoring system 31 sends a request every 5 minutes, the second monitoring system 32 sends a request every 10 minutes, and the third monitoring system 33 sends a request every 15 minutes. In this situation, the cache module 40 will send inquiry, through the data inquiry interfaces 424, to the sensor F every 5 minutes. Moreover, the cache module 40 will send the replied sensor data of the sensor F to the first monitoring system 31 at the fifth minute; send the replied sensor data of the sensor F to the first monitoring system 31 and the second monitoring system 32 at the tenth minute; send the replied sensor data of the sensor F to the first monitoring system 31 and the third monitoring system 33 at the fifteenth minute; and the replied sensor data of the sensor F to the first monitoring system 31, the second monitoring system 32 and the third monitoring system 32 at the thirtieth minute.

In other word, the cache module 40 will not have unnecessary repeated inquiry for the sensor F when the cache module 40 judges that various monitoring systems send requests to the same inquired sensor. In above mentioned thirty minutes duration, the first monitoring system 31 sends six requests, the second monitoring system 32 sends three requests, and the third monitoring system 33 sends two requests. However, the sensor F is only inquired six times by the cache module 40, namely, the inquired times of the sensor F is reduced by 45%.

Moreover, the cache module 40 can automatically adjust the inquiry frequency. For example, the front-end monitoring systems 3 may have periodical request (for example, one request for every 10 seconds) to the cache device 4 if the front-end monitoring systems 3 has activated instant monitoring function. Accordingly, the cache module 40 has to send inquiry to the inquired sensor every 10 seconds. Meaningless waste problem occurs when the front-end monitoring systems 3 turns off the instant monitoring function while the cache module 40 is not aware of this and still sends inquiry to the inquired sensor every 10 seconds. In the present embodiment, the cache module 40 can notice the change in asked replying frequency from the front-end monitoring systems 3 and then adjust (increase or decrease) the frequency for sending inquiry (namely, the inquiry frequency) to the inquired sensor, thus lowering the overall loading of the system.

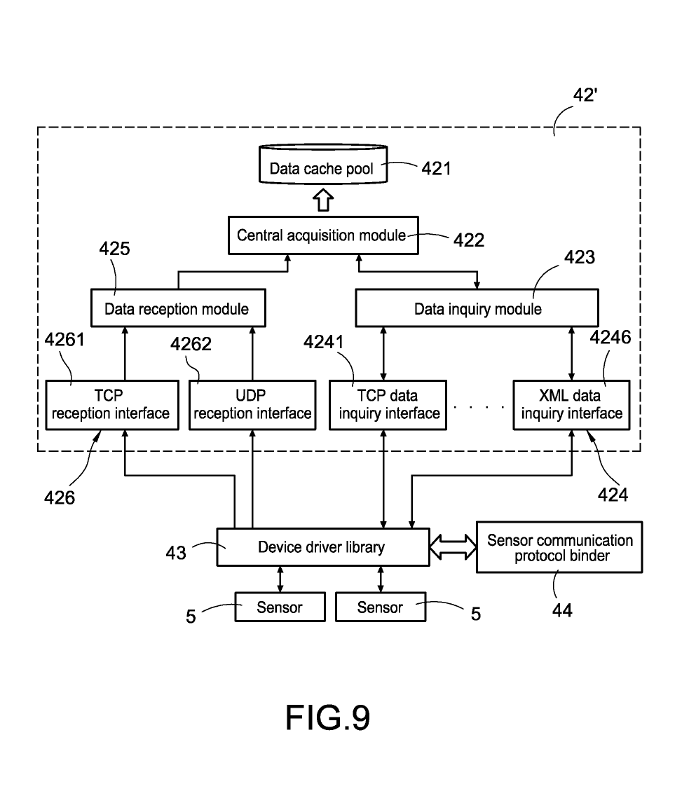

FIG. 9 shows the schematic diagram of the cache module according to the second embodiment of the present invention. The sensor data acquisition module 42′ shown in FIG. 9 is similar to the sensor data acquisition module 42 shown in FIG. 3, and the difference is that the sensor data acquisition module 42′ further includes a data reception module 425 and a plurality of data reception interfaces 426, where the data reception interfaces 426 are corresponding to different reception mechanisms. More particularly, the data reception interfaces 426 connect to such sensors which are not allowed to inquire and will actively upload sensor data. Therefore, the data reception interfaces 426 will listen to the sensor 5 through the data inquiry interfaces 424 instead of inquiring the sensor 5.

The data reception interfaces 426 respectively executes the driver programs in the device driver library 43 to connect to, listen to and receive uploaded data from the inquired sensors 5. The data reception module 425 controls the data reception interfaces 426 and obtains data received thorough the data reception interfaces 426. In this embodiment, the central acquisition module 422 simultaneously collects data from the data inquiry module 423 and the data reception module 425, and then temporarily stores the data to the data cache pool

As shown in FIG. 9, the data reception interfaces 426 mainly comprises a TCP reception interface 4261 to listen to and receive uploaded data from the TCP type sensor and a UDP reception interface 4262 to listen to and receive uploaded data from the UDP type sensor.

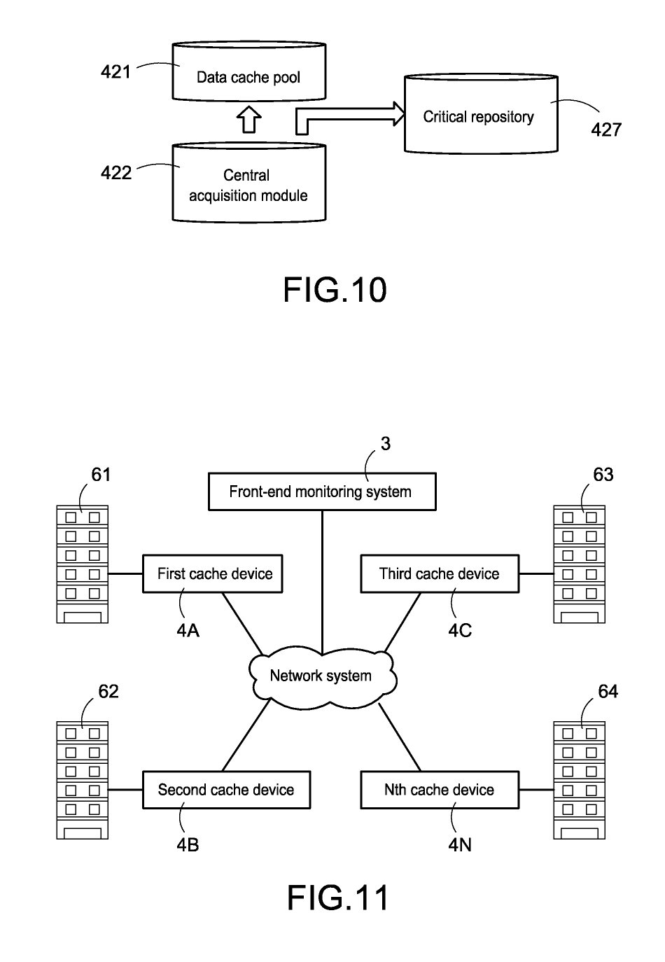

FIG. 10 shows the schematic diagram of the cache module according to the third embodiment of the present invention. As shown in FIG. 10, the sensor data acquisition module 42 further comprises a critical repository 427. The critical repository 427 is different with the data cache pool 421 in that critical repository 427 stores only critical data instead of all sensor data. After the central acquisition module 422 collects data from the data inquiry module 423 and the data reception module 425, the central acquisition module 422 will abstract, with reference to system default setting, critical (namely, important) data from the collected sensor data and then store the critical data in the critical repository 427 as the sensor data is stored in the data cache pool 421. The critical repository 427 stores critical sensor data, for example main power meter data, whereby the system impact can be minimized when the cache device 4 is repaired from damage.

FIG. 11 shows the connection diagram for the second embodiment of the present invention. In this embodiment, the cache device 4 can be seen as an augmented sensor including a plurality of smaller sensors 5. As shown in FIG. 11, the first building 61 is arranged with a first cache device 4A, the second building 62 is arranged with a second cache device 4B, the third building 63 is arranged with a first cache device 4C, and the Nth building 64 is arranged with an Nth cache device 4N. Therefore, the front-end monitoring systems 3 can obtain sensor data from all sensors in the all buildings 61-64 by sending request to the first cache device 4A to the Nth cache device 4N to, no matter how many buildings 61-64 and how many sensors 5 are arranged in the buildings 61-64.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A cache device for sensor data, the cache device operatively connected to a front-end monitoring system and a plurality of sensors and comprising a cache module, the cache module comprising:
a sensor data access interface receiving at least one request sent from the front-end monitoring system and requesting sensor data from the sensors;
a sensor data acquisition module sending inquiry to the sensors according to the request and temporarily storing sensor data from the sensors after receiving the sensor data, the sensor data acquisition module replying the sensor data to the front-end monitoring system through the sensor data access interface; and
a device driver library storing a plurality of driver programs and operatively connected to the sensor data acquisition module, wherein the sensor data acquisition module reads the sensor through executing the driver programs;
wherein the device driver library selects at least one corresponding communication protocol used by the sensors, the driver programs are executed to communicate with the sensors according to the corresponding communication protocol.

2. The cache device in claim 1, wherein the cache module further comprises a sensor communication protocol binder for recording a plurality of communication protocols, the device driver library is configured to access the sensor communication protocol binder to read the communication protocols corresponding to the sensors and used by the driver programs.

3. The cache device in claim 1, wherein the cache module further comprises:
a data cache pool for temporarily storing the sensor data replied by the sensors;
a plurality of data inquiry interfaces corresponding to different inquiry types, the data inquiry interfaces respectively executing one of the driver programs to send inquiry to the sensors with a corresponding type and respectively receiving sensor data from the sensors; and
a data inquiry module configured to send inquiry to the sensors through controlling the plurality of data inquiry interfaces and to receive the sensor data replied from the plurality of data inquiry interfaces, wherein the data inquiry interfaces send inquiry to the sensors at an inquiry frequency and the inquiry frequency is corresponding to an asked replying frequency of the front-end monitoring system.

4. The cache device in claim 3, wherein the data inquiry interface include at least one of transmission control protocol (TCP) data inquiry interface, serial data inquiry interface, web service data inquiry interface, hypertext transfer protocol (HTTP) data inquiry interface, database service data inquiry interface, and XML data inquiry interface.

5. The cache device in claim 3, wherein the sensor data acquisition module further comprises:
a plurality of reception interfaces corresponding to different data reception types, the plurality of reception interfaces listening to and receiving uploaded data from the sensors by executing respective driver program;
a data reception module configured to control the plurality of reception interfaces and receive the replied sensor data of the sensors through the plurality of reception interfaces; and
a central acquisition module configured to collect the sensor data received by the data inquiry module and the data reception module and temporarily the sensor data in the data cache pool.

6. The cache device in claim 5, wherein the reception interface is at least one of TCP reception interface and user datagram protocol (UDP) reception interface.

7. The cache device in claim 5, wherein the sensor data acquisition module further comprises a critical repository, the sensor data acquisition module judges the sensor data to be critical data according to a system default setting, the sensor data acquisition module storing the critical data in the critical repository as the sensor data acquisition module storing sensor data to the data cache pool.

8. The cache device in claim 3, wherein the device driver library further comprises a plurality of adapters respectively connected to the data inquiry interfaces and the driver programs such that the data inquiry interface executes at least one driver program.

9. The cache device in claim 3, wherein the sensor data access interface periodically replies the sensor data to the front-end monitoring system according to the request of the front-end monitoring system for the sensors and the asked replying frequency of the front-end monitoring system, wherein the sensor data access interface comprises a TCP proactive data sensor interface and a UDP broadcasting data sensor interface, the TCP proactive data sensor interface replying the sensor data to the front-end monitoring system through TCP communication protocol, the UDP broadcasting data sensor interface replying the sensor data to the front-end monitoring system through UDP communication protocol.

10. The cache device in claim 9, wherein the sensor data access interface comprises a TCP responsive data sensor interface, the TCP responsive data sensor interface replies the sensor data to the front-end monitoring system through UDP communication protocol as the TCP responsive data sensor interface receives request from the front-end monitoring system.

11. A cache method using the cache device in claim 1, comprising:
a) receiving request for a plurality of sensors from a front-end monitoring system and receiving an asked replying frequency from the front-end monitoring system;
b) periodically sending inquiry to the sensor according to the asked replying frequency;
c) receiving and temporarily storing sensor data replied from the sensors; and
d) periodically replying the sensor data to the front-end monitoring system according to the asked replying frequency.

12. The cache method in claim 11, further comprising following steps before the step b:
judging communication protocol used by the sensors; and
communicating with the sensors through the communication protocol complied with the sensors.

13. The cache method in claim 12, further comprising following steps
e) judging whether other monitoring system sends request to the same sensors;
f) determining an optimal replying frequency by referring to asked replying frequencies from other monitoring system if the other monitoring system sends request to the same sensors;
g) sending inquiry to the sensors according to the optimal replying frequency, receiving and temporarily storing the sensor data from the sensors; and
h) sending the sensor data to the monitoring system according to the optimal replying frequency.

14. The cache method in claim 13, wherein the optimal replying frequency is a highest common factor of the asked replying frequencies from all monitoring systems.

15. A cache device for sensor data, the cache device operatively connected to a front-end monitoring system and a plurality of sensors and comprising a cache module, the cache module comprising:
a sensor data access interface receiving at least one request sent from the front-end monitoring system and requesting sensor data from the sensors;
a plurality of data inquiry interfaces corresponding to different inquiry types;
a plurality of data reception interfaces corresponding to different reception types;
a device driver library storing a plurality of driver programs, the plurality of data inquiry interfaces executing at least one of the driver programs to send inquiry to the sensors of the corresponding type and to receive the sensor data from the sensors, the plurality of data reception interfaces executing at least one of the driver programs to listen to uploaded sensor data of the sensors;
a data inquiry module configured to send inquiry to the sensors through controlling the plurality of data inquiry interfaces and to receive the sensor data replied from the plurality of data inquiry interfaces, wherein the data inquiry interfaces send inquiry to the sensors at an inquiry frequency and the inquiry frequency is corresponding to an asked replying frequency of the front-end monitoring system;
a data reception module configured to control the plurality of reception interfaces and receive the replied sensor data of the sensors through the plurality of reception interfaces; and
a data cache pool;
a central acquisition module configured to collect the sensor data received by the data inquiry module and the data reception module and temporarily the sensor data in the data cache pool; and
a sensor communication protocol binder for recording a plurality of communication protocols;
wherein the device driver library is configured to access the sensor communication protocol binder to read the communication protocols corresponding to the sensors and used by the driver programs, the driver programs are executed to communicate with the sensors according to the corresponding communication protocol.

16. The cache device in claim 15, wherein the data inquiry interface include at least one of transmission control protocol (TCP) data inquiry interface, serial data inquiry interface, web service data inquiry interface, hypertext transfer protocol (HTTP) data inquiry interface, database service data inquiry interface, and XML data inquiry interface.

17. The cache device in claim 15, wherein the data reception interface is at least one of TCP reception interface and user datagram protocol (UDP) reception interface.

18. The cache device in claim 15, wherein the sensor data acquisition module further comprises a critical repository, the sensor data acquisition module judges the sensor data to be critical data according to a system default setting, the sensor data acquisition module storing the critical data in the critical repository as the sensor data acquisition module storing sensor data to the data cache pool.

19. The cache device in claim 15, wherein the device driver library further comprises a plurality of adapters respectively connected to the data inquiry interfaces and the driver programs such that the data inquiry interfaces executes at least one driver program, the adapters respectively connected to the data reception interfaces such that the data reception interfaces execute at least one driver program

20. The cache device in claim 15, wherein the sensor data access interface comprises a TCP proactive data sensor interface, a UDP broadcasting data sensor interface and a TCP responsive data sensor interface, the TCP proactive data sensor interface and the UDP broadcasting data sensor interface periodically reply the sensor data to the front-end monitoring system according to the request of the front-end monitoring system for the sensors and the asked replying frequency of the front-end monitoring system, the TCP proactive data sensor interface replying the sensor data to the front-end monitoring system through TCP communication protocol, the UDP broadcasting data sensor interface replying the sensor data to the front-end monitoring system through UDP communication protocol, the TCP responsive data sensor interface replies the sensor data to the front-end monitoring system through UDP communication protocol as the TCP responsive data sensor interface receives request from the front-end monitoring system.
